(19) United States
(12) Patent Application Publication
(10) Pub. No.: US 2007/0245519 A1
(43) Pub. Date: Oct. 25, 2007

(54) Complex type door checker

(76) Inventor: Sang Hyuk Woo, Gyeongsangbuk-do (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/432,320

(22) Filed: May 12, 2006

(30) Foreign Application Priority Data
Apr. 21, 2006 (KR) 10-2006-36370

(51) Int. Cl. E05F 5/02

(52) U.S. Cl. 16/86 C

(57) ABSTRACT

A complex type door checker includes an arm having a curved portion formed on its one surface and having its one end connected to a vehicle via a hinge, a friction checker friction-contacting with one surface of the arm, a rolling checker rolling-contacting with another surface of the arm, and a case including the friction checker and the rolling checker in its inside and installed on one side of a door. In this instance, the friction checker includes a slider and the rolling checker includes a roller, a carrier and a roller spring. Since the complex type door checker constructed as above decreases a rocking phenomenon when opening/closing a door and also reduces a friction, a door can be smoothly opened/closed.

### BACKGROUND OF THE INVENTION

1. Field of the Invention

The present invention relates to a complex type door checker, and more particularly, to a complex type door checker combining a roller type door checker and a slide door checker.

2. Description of the Background Art

Generally, if a door of a vehicle only has an opening function when the door is released from a locking device, the door keeps rocking even by a little force, even after the door is opened. Also, when a door is opened in an inclined road, unless an external force is applied to the door and supports the door, the door becomes completely open or closed.

Accordingly, a stop function of temporarily holding a door in a necessary point when opening the door is provided to the door. A device performing the above-described function is a door checker.

The door checker forms a curved portion in an opening/closing path of a door so as to temporarily stop the door, and moves again when an external force is applied to the door in the static state.

A conventional door checker may be generally divided into a slide type door checker and a roller type door checker.

As shown in FIG. 1, the slide type door checker includes an arm 50 which has its one end connected to a bracket of a vehicle and is formed with a curved portion so as to adjust an opening/closing force, and a checker 65 which is combined with the arm 50.

The checker 65 includes a case 60, a pair of sliders 62 which are provided in the case 60 and contact with both top and bottom surfaces of the arm 50 respectively, and a pair of cushions 61 which support the pair of sliders 62 and elastically push the same towards the arm 50.

However, as shown in a graph (A) of FIG. 2, in the case of the conventional slider type door checker constructed as above, the coefficient of friction is high. Accordingly, when opening/closing a door, a door operates stiffly due to a friction even after the coefficient of friction hits each pick value.

As shown in FIG. 3, the roller type door checker includes an arm 70 which has its one end connected to a bracket of a vehicle and is formed with a curved portion so as to adjust an opening/closing force, and a checker 90 which is combined with the arm 70.

The checker 90 includes a case 80, a guide 85 which is provided in the center of the case 80, a pair of springs 84 which are provided on both ends of the case, a pair of carrier 83 which are supported by an elastic force of the pair of springs 84, and a pair of rollers 82 which are inserted with a pair of pin rollers 81.

However, as shown in a graph (A) of FIG. 4, in the case of the roller type door checker constructed as above, a door operates very smoothly, but the coefficient of friction is extremely low. Accordingly, a door rocks several times in the middle of the arm 70. Also, since a manufacturing cost is about twice higher than the conventional slide type door checker, productivity is decreased.

### SUMMARY OF THE INVENTION

Accordingly, an objective of the present invention is to provide a complex type door checker which applies an appropriate friction and thereby provides an improved opening/closing function of a door.

To achieve the aforementioned objective of the present invention, according to an aspect of the present invention, there is provided a complex type door checker including: an arm having a curved portion formed on its one surface and having its one end connected to a vehicle via a hinge; a friction checker friction-contacting with one surface of the arm; a rolling checker rolling-contacting with another surface of the arm; and a case including the friction checker and the rolling checker in its inside and installed on one side of a door.

In this instance, the friction checker includes only a slider which contacts with one surface of the arm. Also, the rolling checker includes a roller which rotatably contacts with one surface of the arm, a roller pin which fixes the roller to a carrier, the carrier which is fixed by the roller pin, and a roller spring which closely attaches the roller on one surface of the arm.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is an exploded perspective view illustrating a structure of a conventional slide type door checker according to the conventional art;

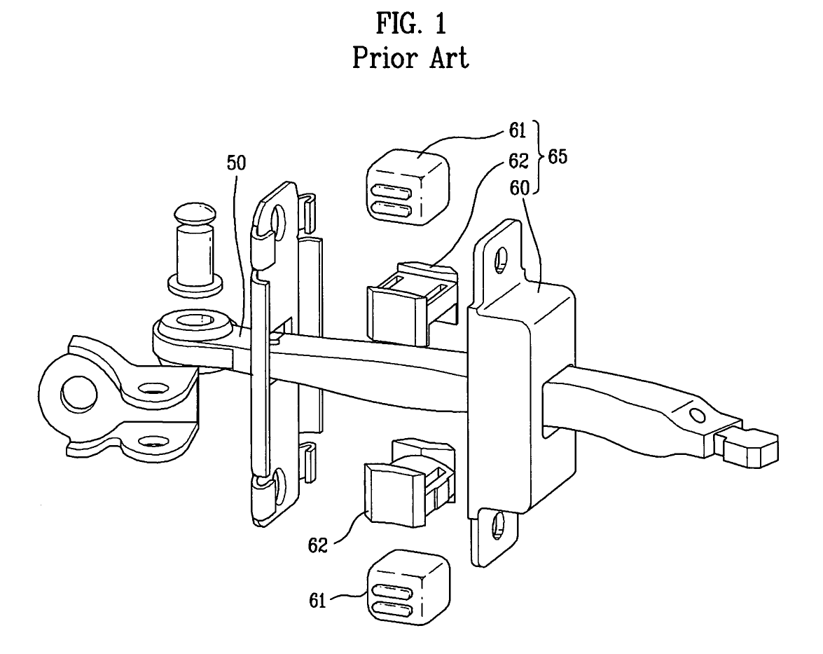

FIG. 2 is a graph comparing the change of an opening/closing force between a conventional slide type door checker and a complex door checker;

FIG. 3 is an exploded perspective view illustrating a structure of a conventional roller type door checker;

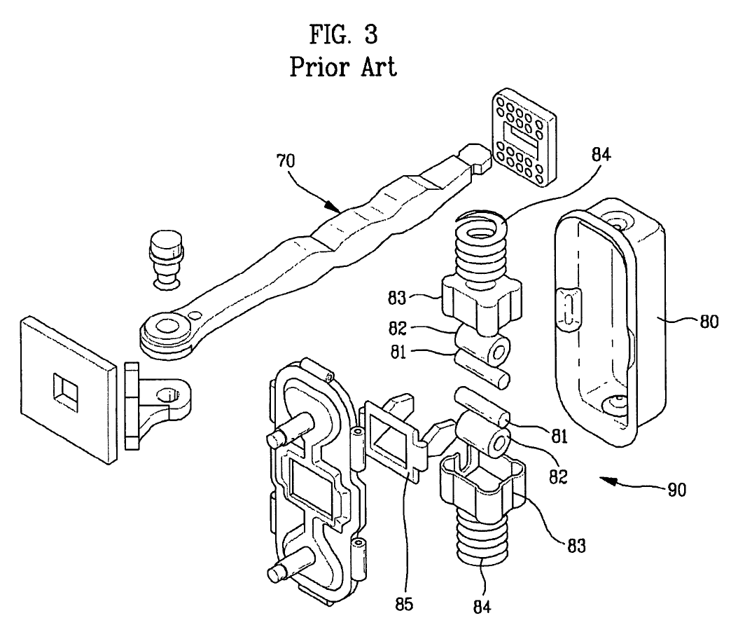

FIG. 4 is a graph comparing the change of an opening/closing force between a conventional roller type door checker and a complex door checker;

FIG. 5 is an exploded perspective view illustrating a structure of a door checker according to the present invention; and

FIG. 6 is an explicit perspective view illustrating the door checker according to the present invention.

### DETAILED DESCRIPTION OF THE PREFERRED EMBODIMENTS

Hereinafter, an exemplary embodiment of a complex door checker according to the present invention will be described in detail with reference to the accompanying drawings.

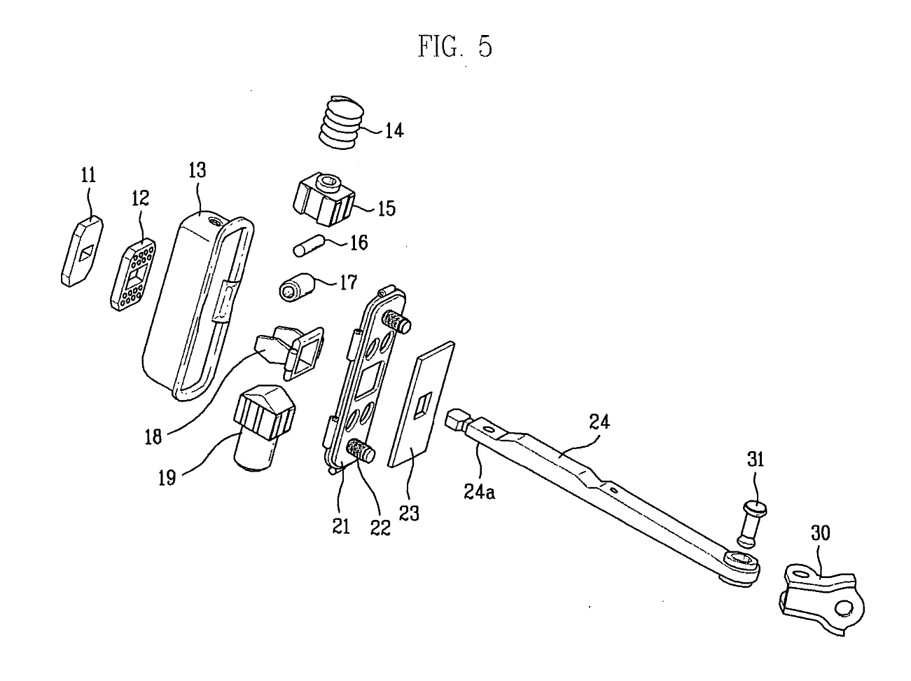

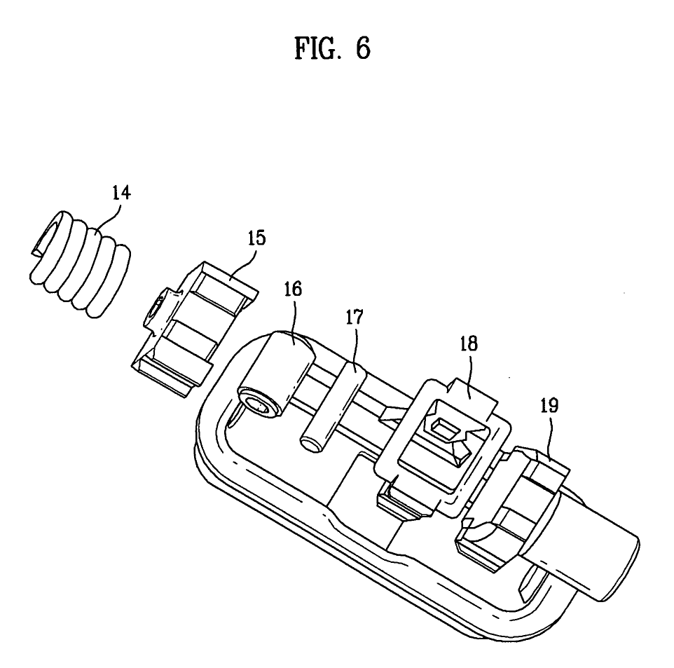

FIG. 5 is an exploded perspective view illustrating a structure of a door checker according to the present invention and FIG. 6 is an explicit perspective view illustrating the door checker according to the present invention.

As shown in FIGS. 5 and 6, a complex type door checker according to the present invention includes an arm 24, a slider 19, a roller 17, a carrier 15, a spring 14, a guide 18 and a case 13. Specifically, the arm 24 has a curved portion 24a on its one surface and has its one end combined with a bracket 30 via a pin 31 in which the bracket 30 is mounted to a vehicle (not shown). The slider 19 contacts with a bottom surface of the arm 24 and the roller 17 contacts with a top surface of the arm 24. The carrier 15 is coupled with the roller 17 via a pin roller 16 and the spring 14 pushes the carrier 24 towards the arm 24. Also, the guide 18 is interposed between the roller 17 and the slider 19. The case 13 includes the slider 19, the roller 17, the carrier 15, the spring 14, the guide 18, and the like, in its inside, and is installed on one side of a door.

A plate base 21 which is formed with a bolt 22 for combination with a door (not shown) is provided on one side of the case 13, that is, towards the bracket 30 of a vehicle. Also, a pad 23 is mounted on one side of the plate base 21.

A stopper 12 which stops the movement of the arm 23 and a plate stop portion 11 which supports the stopper 12 are provided on another side of the case 13, that is, inside of a door.

The complex type door checker according to the present invention constructs a roller type checker and a slide type checker on the top and bottom surfaces of the arm 24 on the basis thereof. Through this, smooth opening/closing of the roller 17 and appropriate friction of the slider 19, which contact with both surfaces of the arm 24 respectively, may be embodied.

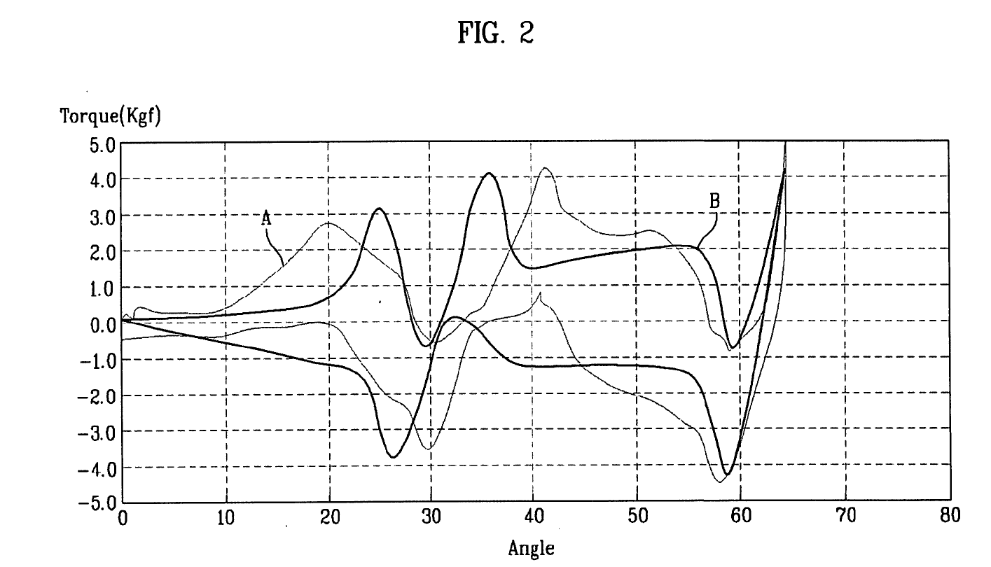

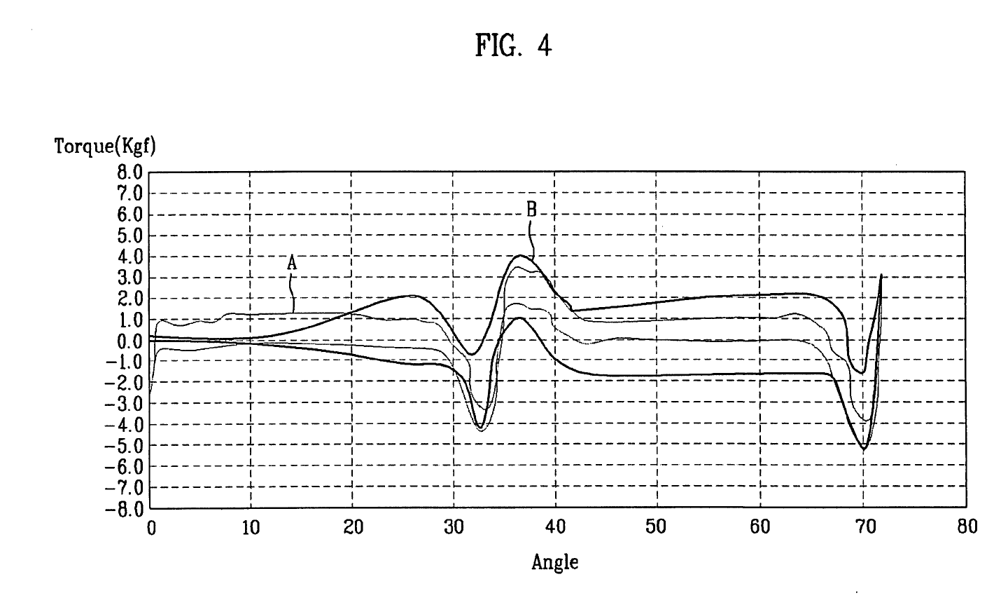

Namely, while the complex type door checker secures opening/closing in the curved portion of the arm 24 as an opening/closing force line shown in each (B) of graphs of FIGS. 2 and 4, the complex door checker makes a door be opened/closed in other portions excluding the curved portion of the arm 24, by almost constant opening/closing force.

Also, even when opening a door hard, the complex type door checker constructed as above may decrease a repelling power by a constant opening/closing force. Accordingly, a phenomenon of a door being suddenly closed by a spring, which is shown in the conventional roller type, may be prevented.

According to the present invention, in comparison with the conventional roller type door checker, it is possible to reduce a manufacturing cost, prevent a rocking phenomenon caused by inertia, and help smooth opening/closing. Also, according to the present invention, in comparison with the conventional slide type door checker, it is possible to reduce friction and provide smooth opening/closing. Namely, according to the present invention, it is possible to embody modulation and durability of the roller type and also to control a door's rocking by using friction of the slider type.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A complex type door checker comprising:
an arm having a curved portion formed on its one surface and having its one end connected to a vehicle via a hinge;
a friction checker friction-contacting with one surface of the arm; a rolling checker rolling-contacting with another surface of the arm; and
a case including the friction checker and the rolling checker in its inside and installed on one side of a door.

2. The complex type door checker of claim 1, wherein the friction checker comprises a slider contacting with one surface of the arm

3. The complex type door checker of claim 1, wherein the rolling checker comprises a roller rotatably contacting with one surface of the arm, a roller pin fixing the roller to a carrier, the carrier fixed by the roller pin, and a roller spring closely attaching the roller on one surface of the arm.
